(19) United States
(12) Patent Application Publication
(10) Pub. No.: US 2020/0317455 A1
(43) Pub. Date: Oct. 8, 2020

(54) MODULAR AND IMPACTABLE FRAME WITH INTEGRATED LEVELER

(71) Applicant: Leum Engineering, Inc., Excelsior, MN (US)

(72) Inventors: Grant Leum, Excelsior, MN (US); Eric Demerath, Shepherd, MI (US)

(73) Assignee: Leum Engineering, Inc., Excelsior, MN (US)

(21) Appl. No.: 16/376,898

(22) Filed: Apr. 5, 2019

(51) Int. Cl. B65G 69/24; B65G 69/28

(52) U.S. Cl. CPC B65G 69/24; B65G 67/02; B65G 69/2811

(57) ABSTRACT

A modular and impactable frame which includes an integrated dock leveler. The frame includes opposing front plates, opposing side members, opposing base members and an integral bracing structure which connects each side member to a respective base member, the base members each have a base plate and a pair of front and back supporting legs, each base plate is secured to the grade and is adjustable in a side-to-side direction as well as adjustable in a front-to-back direction so as to securely attach to the grade.

### FIELD OF THE INVENTION

This invention relates to dock levelers and more particularly to a dock leveler which is integrated into a modular frame and is able to withstand and transfer an impact from a vehicle.

### BACKGROUND OF THE INVENTION

A variety of dock levelers both with and without surrounding structural frames have been devised to adjust the height of different trailers to properly match the deck of the trailer to the height of the dock. By aligning the height of the trailer and the dock the loading and unloading of cargo is facilitated.

One such device is seen in U.S. Pat. No. 4,624,446 to Gould which discloses a reinforced platform pivotally mounted to the ground at one end and includes a support assembly having hydraulic cylinders. In operation the rear wheels of a truck trailer are backed onto the platform and then the non-mounted end of the platform is lifted by the hydraulic cylinders until the deck of the trailer is equal to the height of the dock.

A similar device is disclosed in U.S. Pat. No. 4,765,792 to Cherry, et al. which also discloses a pivotally-mounted and hydraulically-raised platform. In addition to the disclosure of Gould, the device includes mounting the hydraulics inwardly from the non-mounted end of the platform and an aperture in the non-mounted end of the platform to accommodate a truck restraining device.

Another design is disclosed in U.S. Pat. No. 6,368,043 to Leum, et al. which teaches a low-profile truck leveler. In this design a low-profile leveler is enabled through the use of a raised rear beam and two lateral beams that extend above the upper surface of the platform. In addition, a central beam adds further to the leveler's strength and rigidity.

Some dock levelers of the prior art include surrounding frame structure, however, none of these levelers include the leveler being integrated into a frame which is modular, impactable and highly adjustable for added safety. It is to this need that this invention is drawn.

This device overcomes certain problems and shortcomings in the prior art, including those mentioned above and others, and provides advantages for a dock leveler integrated into a modular, impactable and adjustable frame not previously provided.

### SUMMARY OF THE INVENTION

A modular and impactable frame which includes an integrated dock leveler with a planar member, the frame has opposing front plates, opposing side members, opposing base members and an integral bracing structure connecting each side member to a respective base member. It is highly preferred that the base members each have a base plate and a pair of front and back supporting legs, each base plate being secured to the grade and being adjustable in a side-to-side direction as well as adjustable in a front-to-back direction so as to securely attach to the grade.

It is highly preferred that each base plate is able to be adjusted independent of the opposing base plate. Preferably, the base plate includes one or more adjustment structures, the adjustment structure has a locking bolt, top nut and a bottom.

It is preferable that the front plates absorb impact from a vehicle and transfers an impact load to the integral bracing structure and base plate. In some applications it is preferable that a dock housing can be secured to planar member or frame. In other applications it is preferable that the frame can be bolted to a mobile loading dock or a loading platform.

In preferred embodiments, the base plate is secured to the grade by one or more bolts and the frame includes a back plate which can be bolted to a wall of a building.

The term “impactable” as used herein refers to a frame which can withstand and transfer an impact load from a vehicle.

### BRIEF DESCRIPTION OF THE DRAWINGS

The drawings illustrate preferred embodiments including the above-noted characteristics and features of the device. The device will be readily understood from the descriptions and drawings. In the drawings:

FIG. 1 is a front perspective view of a loading dock frame;

FIG. 2 is a top view of the frame of FIG. 1;

FIG. 3 a front perspective view of the frame of FIG. 1;

FIG. 4 is a side view of the frame of FIG. 1;

FIG. 5 is a cutaway view taken along line 5-5 of FIG. 1;

FIG. 6 is a side perspective view of the frame of FIG. 1 attached to the wall of a building;

FIG. 7 is a front perspective view of the frame of FIG. 1 with a dock housing;

FIG. 8 is a cutaway view taken along line 8-8 of FIG. 7; and

FIG. 9 is a perspective view of the frame of FIG. 1 in use with a mobile loading dock.

### DETAILED DESCRIPTION OF PREFERRED EMBODIMENTS

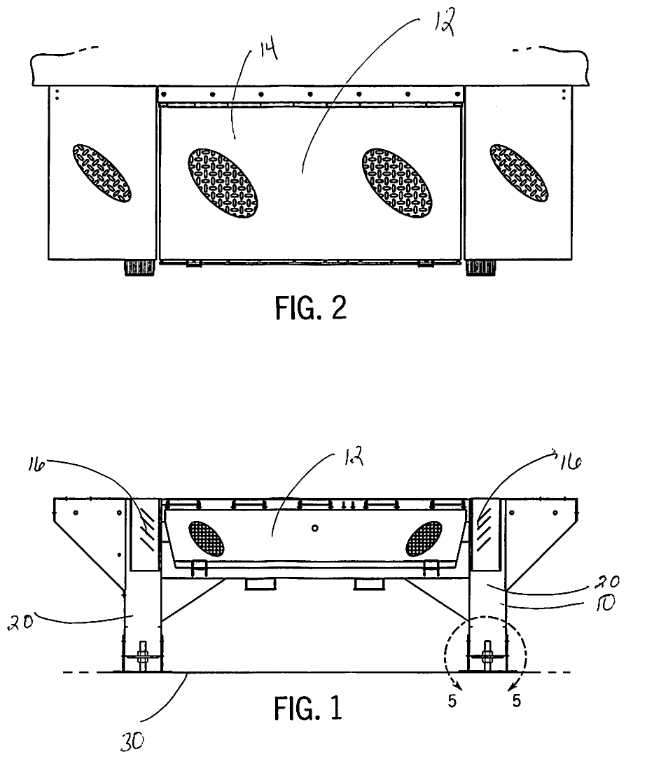

FIGS. 1-9 illustrate an impactable and modular frame 10 with an integrated hinged dock leveler 12. Frame 10 is self-standing (it can operate as a stand alone platform and does not need any other structure to function) but frame 10 is versatile as well as modular as it can also be used with any platform, ramp, dock housing or an existing building.

Frame 10 includes integrated dock leveler 12 which is a planar member 14. Frame 10 also includes opposing front plates 16, opposing side members 18, opposing base members 20 and an integral bracing structure 22 connecting each side member 18 to a respective base member 20 as can be seen in FIGS. 1-4.

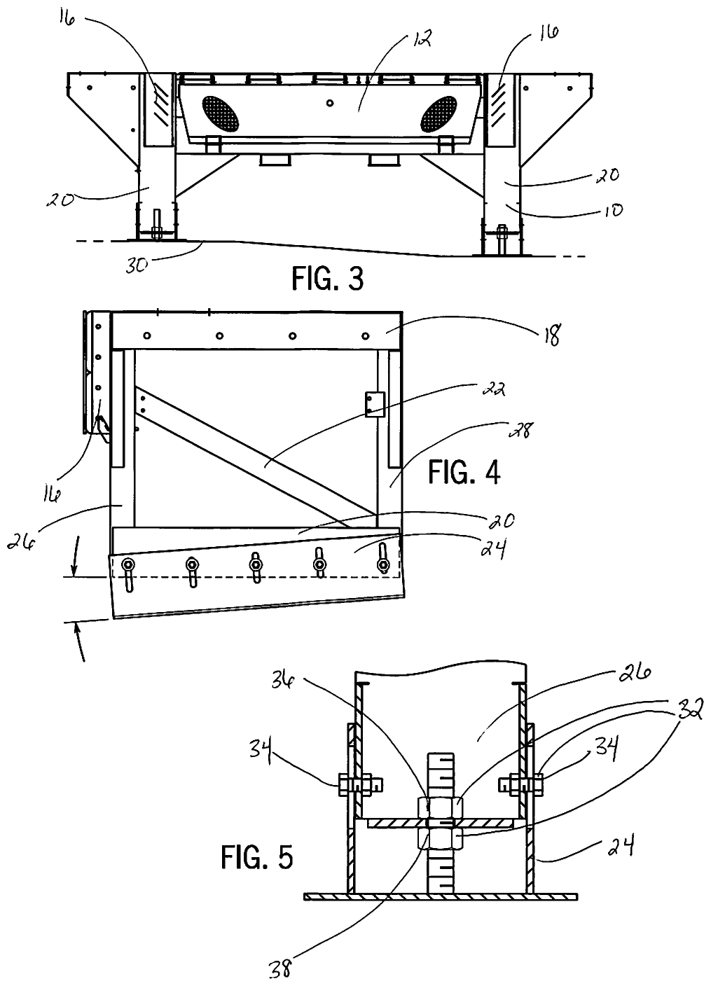

Opposed front plates 16 act as bumpers (see FIGS. 1 and 3) to protect frame 10 from impact with a vehicle and also to protect dock leveler 12 from impact should a vehicle back up too far and bump into frame 10. Opposed front plates if impacted absorb the impact from a vehicle and transfers the impact load to both integral bracing structure 22 and base plate 24.

FIG. 2 illustrates the location of dock leveler 12 in the middle section of frame 10. Next to dock leveler 12 on each side are flat side portions (not claimed) which function to provide a larger work area on top of frame 10 for use when loading or unloading cargo. These flat side portions can also provide an area to secure additional structures, such as a dock housing 40 to frame 10 as seen in FIG. 7.

FIGS. 4-5 illustrate that base members 20 each have a base plate 24 and a pair of front supporting legs 26 and a pair of back supporting legs 28. As can be seen best in FIG. 5, each base plate 24 is secured to the grade 30. FIGS. 4-5 illustrate that base plate 24 is adjustable in a side-to-side direction as well as adjustable in a front-to-back direction so as to securely attach to grade 30.

Arrows in FIG. 4 indicate that the base plate can be adjusted in various directions based on the contour of grade 30. It is important to note that each side of frame 10 has a base plate 24 and that base plates 24 on either side are able to adjusted independent of the other base plate 24 on the other side of frame 10. Being able to adjust base plate 24 to the exact contour of grade 30 allows for a more secure attachment to grade 30 and greater stability of frame 10. Base plate 24 can be secured to any type of grade 30 including but not limited to gravel, asphalt or concrete. It is important to note that frame 10 can secured to ground 30 by any known method and all such methods are within the scope of the application.

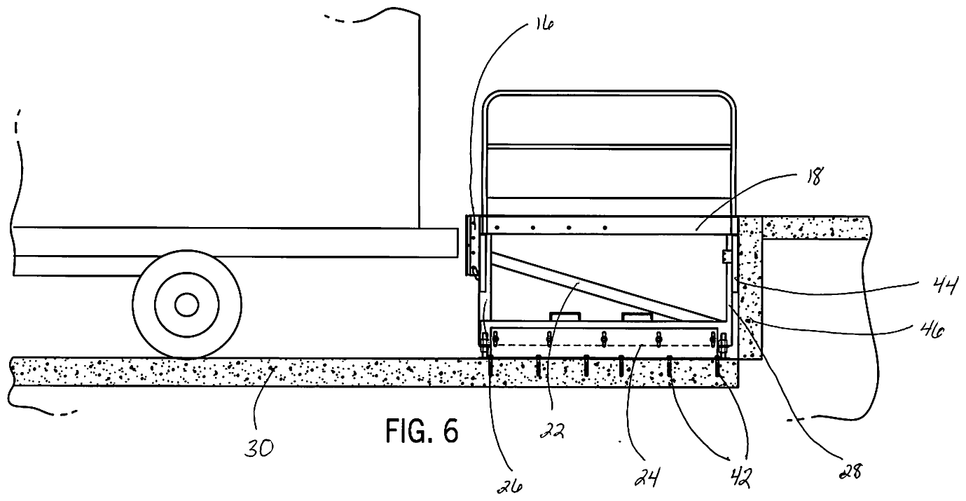

FIG. 4 illustrates that for added structural support frame 10 has integral bracing structure 22 on each side of frame 10. FIG. 5 shows in detail how either front supporting leg 26 or back supporting leg 28 are attached to base plate 24 and how base plate 24 can be adjusted. Front supporting leg 26 or back supporting leg 28 are secured to base plate 24 through the use of adjustment structures 32. Adjustment structures 32 consist of several locking bolts 34 as well as a top nut 36 and a bottom nut 38 as seen in FIG. 5. This type of securement is used for each of the opposing front supporting legs 26 and back supporting legs 28 of frame 10. Frame 10 can be secured to the wall of a building 46 through the use of a back plate 44 as seen in FIG. 6. Back plate 44 is secured to frame 10 on one side and is secured to the wall of a building 46 on the other side. FIG. 6 also illustrates how grade bolts 42 secure base plate 24 to grade 30. FIG. 6 shows a typical trailer or truck backed up to frame 10 for unloading and/or loading of cargo.

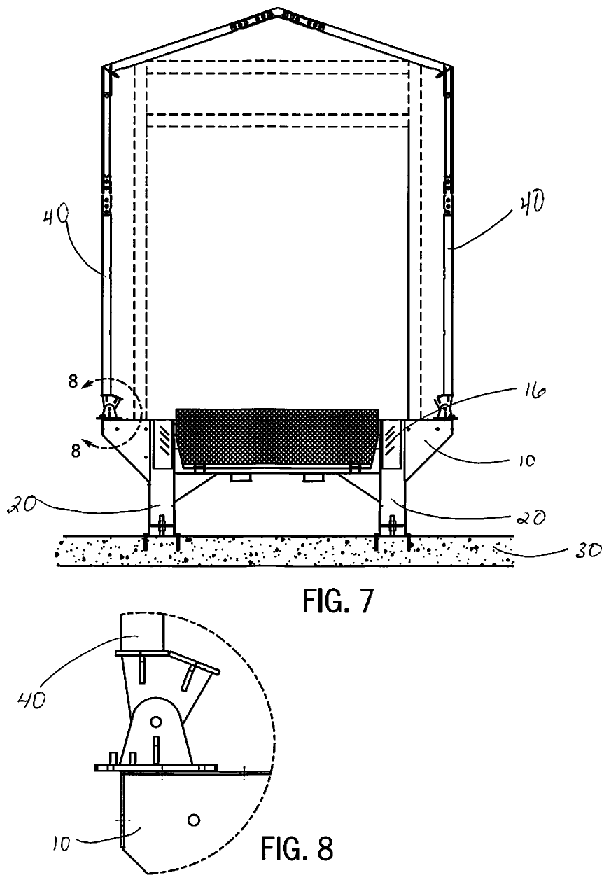

As seen in FIG. 7, a dock housing 40 can be used with frame 10. Dock housing 40 is secured to frame 10 through the use of any type of securement device which would be known in the art. FIG. 8 illustrates one such securement device and illustrates an example of how dock housing 40 can be secured to a top surface of frame 10. Frame 10 can also include handrails for added safety as seen in the figures if a dock housing is not used.

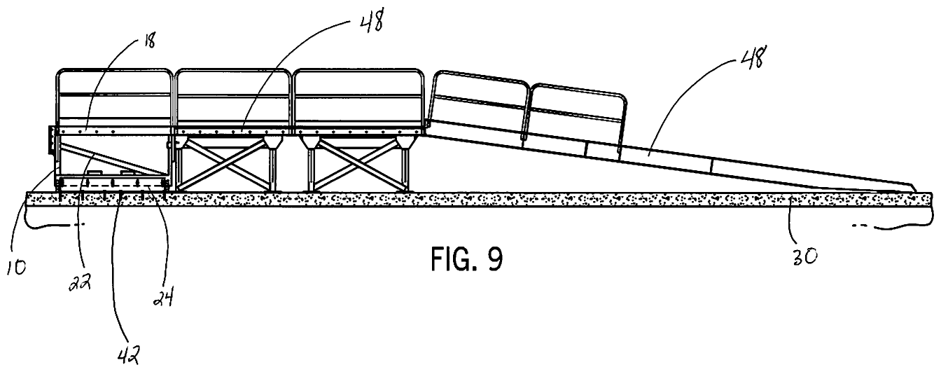

FIG. 9 illustrates that frame 10 can also be used with a mobile loading dock 48. Frame 10 when in use with mobile loading dock 48 works in the same manner as when frame 10 is bolted to a wall of a building 46 or when it is free standing. When in use with a mobile loading dock 48, frame 10 is still secured to grade 30 and can still be adjusted to securely attach to grade 30 as noted above. Frame 10 is secured (typically through the use of several bolts or other securement devices) to mobile loading dock 48 and can be used with mobile loading docks of any size or shape.

A lifting system is also incorporated into the leveler 10 of the first embodiment in the form of hydraulic lifts (not shown). The hydraulic lifts assist in lifting a section of the leveler 10. However, any other lifting systems known in the art could be utilized as well.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A modular and impactable frame having an integrated dock leveler with a planar member, the frame including opposing front plates, opposing side members, opposing base members and an integral bracing structure connecting each side member to a respective base member, the base members each having a base plate and a pair of front and back supporting legs, each base plate being secured to the grade and being adjustable between a left side to right side direction as well as adjustable in a front-to-back direction so as to allow for leveling on uneven ground and to securely attach to the grade, the front plates absorb impact from a vehicle and transfers an impact load to the integral bracing structure and base plate.

2. The frame of claim 1 wherein each base plate is able to be adjusted independent of the opposing base plate.

3. The frame of claim 1 wherein the base plate includes one or more adjustment structures, the adjustment structure having a locking bolt, a first locking nut and a second locking nut.

4. (canceled)

5. The frame of claim 1 wherein a dock housing can be secured to the planar member or frame.

6. The frame of claim 1 wherein the base plate is secured to the grade by one or more bolts.

7. The frame of claim 1 further including a back plate which can be bolted to a wall of a building.

8. The frame of claim 1 wherein the frame can be bolted to a mobile loading dock or a loading platform.
